(19) United States
(12) Patent Application Publication
(10) Pub. No.: US 2007/0143295 A1
(43) Pub. Date: Jun. 21, 2007

(54) Methods, systems, and computer program products for delivering associated content on a communication network

(76) Inventor: Dale Malik, Atlanta, GA (US)

Correspondence Address: MYERS BIGEL SIBLEY & SAJOVEC, P.A., P.O. BOX 37428, RALEIGH, NC, 27627, US

(21) Appl. No.: 11/303,668

(22) Filed: Dec. 16, 2005

(51) Int. Cl. G06F 17/30

(52) U.S. Cl. 707/10

(57) ABSTRACT

Content can be delivered on a communication network by associating additional content elements with media files that may, for example, be purchased by a customer. A customer may select one or more media files that are packaged with one or more associated content elements and communicated, e.g., downloaded, to the customer. Upon receiving media file(s), the user may attempt to use or open the media file(s) at which time the user is presented with the option of accessing, potentially for a fee, one or more additional content elements that are associated with the media file(s). The additional content elements may be “locked” to prevent the customer from using them. The customer may then select one or more of the additional content elements and pay any fee that is required to receive one or more access keys that can be used to open the content elements.

### FIELD OF THE INVENTION

The present invention relates to communications networks, and, more particularly, to distributing media on communication networks.

### BACKGROUND OF THE INVENTION

Communication networks are widely used for nationwide and worldwide communication of voice, multimedia and/or data. As used herein, communications networks include public communications networks, such as the Public Switched Telephone Network (PSTN), terrestrial and/or satellite cellular networks and/or the Internet.

The Internet is a decentralized network of computers that can communicate with one another via Internet Protocol (IP). The Internet includes the World Wide Web (WWW) service facility, which is a client/server-based facility that includes a large number of servers (computers connected to the Internet) on which Web pages or files reside, as well as clients (Web browsers), which interface users with the Web pages. The topology of the World Wide Web can be described as a network of networks, with providers of network services called Network Service Providers, or NSPs. Servers that provide application-layer services may be referred to as Application Service Providers (ASPs). Sometimes a single service provider provides both functions.

Historically, music was sold to customers on vinyl albums or records or on tape. Music later was digitally recorded on compact disc for sale to customers. The Moving Pictures Experts Group (MPEG) encoding standard was developed that provided a format for coding audio and/or video files. The MPEG standard has been used to encode and compress media, such as audio and video, into files that can be more readily communicated over the Internet. Today, many service providers and/or retailers sell audio and/or video content, such as books, music, and movies, over networks such as the Internet and/or cable television network that has been encoded, for example, using the MPEG encoding standard. These media files are generally sold to customers as stand-alone items.

### SUMMARY OF THE INVENTION

According to some embodiments of the present invention, content can be delivered on a communication network by associating additional content elements with media files that may, for example, be purchased by a customer. A customer may select one or more media files that are packaged with one or more associated content elements and communicated, e.g., downloaded, to the customer. Upon receiving media file(s), the user may attempt to use or open the media file(s) at which time the user is presented with the option of accessing, potentially for a fee, one or more additional content elements that are associated with the media file(s). The additional content elements may be “locked” to prevent the customer from using them without authorization. The customer may then select one or more of the additional content elements and pay any fee that is required to receive one or more access keys that can be used to open the content elements.

In particular embodiments of the present invention, associated content may be delivered on a communication network by associating media files with additional content elements, receiving a selection of one of the media files, communicating the selected one of the media files and at least one additional content element associated therewith to a destination, and providing access to the at least one additional content element.

In other embodiments of the present invention, communicating the selected one of the media files comprises communicating the selected one of the media files and at least one additional content element associated therewith to a storage device operated by a service provider and comprising a storage area associated with a user.

In still other embodiments of the present invention, communicating the selected one of the media files comprises communicating the selected one of the media files and at least one additional content element associated therewith to a device operated by a user.

In still other embodiments of the present invention, providing access to the at least one additional content element comprises receiving a user selection of the at least one additional content element responsive to communicating the selected one of the media files and the at least one additional content element to the destination, and communicating an access key for the at least one additional content element to the destination.

In still other embodiments of the present invention, the access key is configured to unlock the at least one additional content element for use by a user.

In still other embodiments of the present invention, a price is assigned to the at least one additional content element based on the selection of the at least one of the media files and/or a user's previous purchases of media files and/or additional content elements associated therewith.

In still other embodiments of the present invention, associating media files with additional content elements comprises associating additional content elements with media files based on a user's previous purchases of additional content elements and/or media files.

In still other embodiments of the present invention, associating media files with additional content elements comprises associating additional content elements with media files based on a user profile that defines the user's media preferences.

In further embodiments of the present invention, a user interface may be provided for delivering content on a communication network. The user interface may operate by presenting at least one media file to a user, the at least one media file having at least one additional content element associated therewith, receiving a selection from the user of one of the at least one media file, communicating the selected one of the at least one media file and the at least one additional content element associated therewith to a destination, and presenting the at least one additional content element to the user responsive to a user selection of the at least one media file at the destination.

In still further embodiments of the present invention, a selection of the at least one additional content element is received from the user. An access key for the at least one additional content element is communicated to the destination responsive to receiving the selection from the user of the at least one additional content element.

In still further embodiments of the present invention, the access key is configured to unlock the at least one additional content element for use by a user.

In still further embodiments of the present invention, presenting the at least one additional content element to the user comprises presenting a price of the at least one additional content element to the user that is based on the selection of the at least one of the media files and/or a user's previous purchases of media files and/or additional content elements associated therewith.

In still further embodiments of the present invention, the selected one of the media files and/or the at least one additional content element has an attached media rule (AMR) associated therewith.

In still further embodiments of the present invention, the AMR comprises price information, expiration date information, purchase information, and/or media enablement information.

In still further embodiments of the present invention, the media enablement information comprises information related to accessing the at least one additional content element.

In still further embodiments of the present invention, the media enablement information comprises information related to a media file other than the selected one of the media files and the at least one additional content element.

Although described primarily above with respect to method aspects of the present invention, it will be understood that the present invention may also be embodied as systems and computer program products.

Other systems, methods, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of the present invention will be more readily understood from the following detailed description of exemplary embodiments thereof when read in conjunction with the accompanying drawings, in which:

FIG. 1 is a block diagram that illustrates a communication network in accordance with some embodiments of the present invention;

FIG. 2 illustrates a data processing system that may be used to implement a media content server of the communication network of FIG. 1 in accordance with some embodiments of the present invention;

FIG. 3 is a block diagram that illustrates a software/hardware architecture for delivering associated content on a communication network in accordance with some embodiments of the present invention;

FIGS. 4 and 6 are flowcharts that illustrate operations for delivering associated content on a communication network in accordance with some embodiments of the present invention; and

FIGS. 5 and 7 are block diagrams of user interfaces for delivering associated content on a communication network in accordance with some embodiments of the present invention.

### DETAILED DESCRIPTION OF EMBODIMENTS OF THE INVENTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

According to some embodiments of the present invention, content can be delivered on a communication network by associating additional content elements with media files that may, for example, be purchased by a customer. For example, a customer may be presented with a user interface that can be used to select one or more media files for purchase. The selected media files may be packaged with one or more associated content elements and communicated, e.g., downloaded, to the customer. Upon receiving media file(s), the customer may attempt to use or open the media file(s) at which time the customer is presented with a user interface in which the associated additional content elements are offered to the user, potentially for a fee. The additional content elements may be “locked” to prevent the customer from accessing the additional content element(s) without paying the required fee, for example. The customer may then select one or more of the additional content elements via the user interface and pay any fee that may be required to receive one or more access keys that can be used to open the content element(s). Upon receiving the key(s), the customer may then unlock, e.g., open and use the additional content element(s) that are packaged and communicated with the original media file(s).

Advantageously, some embodiments of the present invention may allow delivery of additional content with the purchase of one or more media files. The additional content can be promoted for sale within the context of using the purchased media in an ongoing manner. For example, if a customer purchases a MP3 version of a song for his/her cell phone, then the cell phone may display wallpaper associated with the artist when the song is played with a prompt offering the wallpaper for purchase. If the customer elects to purchase the wallpaper, then the cell phone may relay the purchase data necessary to charge the customer's account. Moreover, the price may be embedded with the wallpaper obviating the need to access a content server for price information.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and computer program products in accordance with exemplary embodiments of the invention. These flowchart and/or block diagrams further illustrate exemplary operations for delivering locked content on a communication network, in accordance with some embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

For purposes of illustration, embodiments of the present invention are described herein with respect to associating media files, such as audio, video, and/or graphic files, with other content elements, such as, but not limited to, text, music, games, Musical Instrument Digital Interface (MIDI) files, and/or other audio, video and/or graphic files. It will be understood that the present invention is not limited to such embodiments but may also be embodied generally by associating any media content with any other media content.

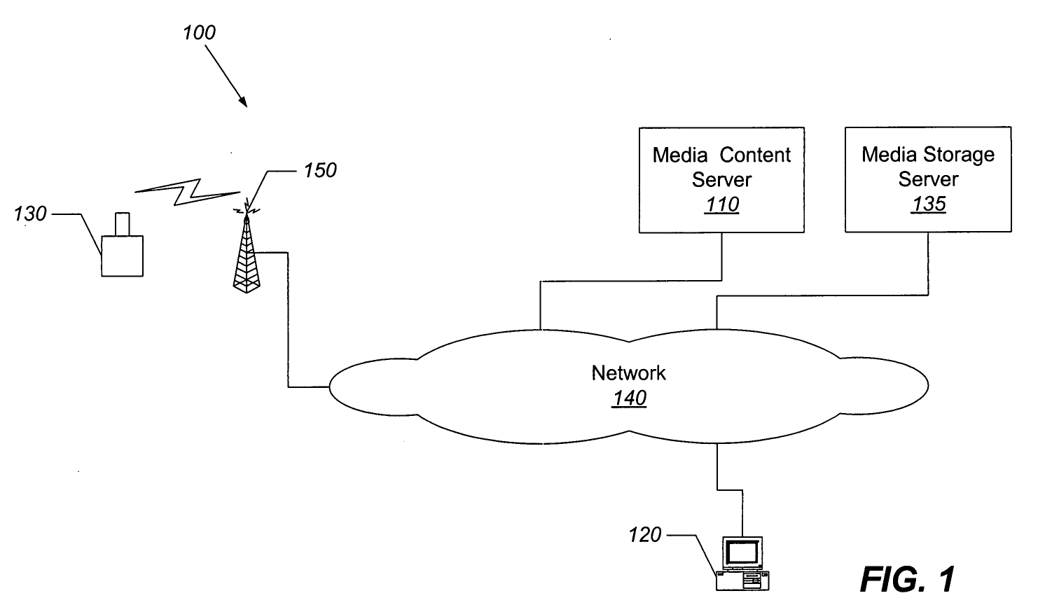

Referring now to FIG. 1, an exemplary network architecture 100 for delivering locked content on a communication network, in accordance with some embodiments of the present invention, comprises a media content server 110, a customer premises equipment (CPE) device, such as a personal computer 120, a wireless phone or mobile terminal 130, and a media storage service provider 135 that are connected to a network 140 as shown. The network 140 comprises a wireless base station transceiver 150 that may facilitate wireless communication with the wireless phone or mobile terminal 130. The network 140 may represent a global network, such as the Internet, or other publicly accessible network. The network 140 may also, however, represent a wide area network, a local area network, an Intranet, or other private network, which may not accessible by the general public. Furthermore, the network 140 may represent a combination of public and private networks or a virtual private network (VPN).

As used herein, the terms “wireless phone” or “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; a conventional laptop; a palmtop receiver or other appliance that includes a radiotelephone transceiver; and/or a portable media player, such as a MP3 player, iPod, or the like. Wireless phones and or mobile terminals may also be referred to as “pervasive computing” devices.

The media content server 110 may be configured to associate one or additional content elements with media files, such as, but not limited to, audio, video, and/or graphic files, for distribution on the communication network 140. As will be described in detail below, the media content server 110 may be configured to present a customer with one or more additional content elements that are associated with media files that are available for customer selection. The additional content elements may be associated with various media files and/or priced based on business rules, a customer's previous purchases of media files, a customer's previous purchases of additional content elements, and/or customer profile information that defines the customer's media preferences. The additional content elements may be downloaded to various destinations, such as a customer's computer, such as personal computer 120 of FIG. 1, or to a customer's wireless phone, such as wireless phone 130 of FIG. 1. The additional content elements may also be downloaded to an online destination, such as the media storage server 135, which has storage space reserved for the customer's files. In accordance with various embodiments of the present invention, the media storage server 135 and the media content server 110 may be associated with the same or different service providers. The associated additional content elements may be referred to as “locked” content because, although they are packaged with a media file that is being purchased or obtained by a customer, the associated additional content elements may not be accessed (i.e., the additional content is “locked”) and used by the customer unless the customer selects the associated additional content and the additional content is either free or the customer pays the additional cost. It will be understood that the associated additional content elements may be bundled with the media file that is being purchased and communicated as a single unit or the associated content elements and media file may be communicated as separate files that are logically related. Advantageously, some embodiments of the present invention may allow a customer to conveniently acquire associated additional content while obtaining other media content, such as an audio, video, or graphic file. For example, a customer may log on to the media content server 110 to purchase a song for downloading. The media content server 110 may package the song with additional content elements, such as another song (e.g., a “side B”), the lyrics of the song, a karaoke version of the song, a MIDI file for the song, one or more images of the artist, and/or even games that the customer may select and purchase. Some of the additional content may even be offered free of charge or free if the customer has a certain membership grade with the service provider running the content media server.

Some embodiments according to the invention can operate in a logically separated client side/server side-computing environment, sometimes referred to hereinafter as a client/server environment. As shown in FIG. 1, a customer's personal computer 120 and/or mobile terminal 130, i.e., clients, may communicate with the media content server 110 and/or the media storage server 135, i.e., servers, over a wireless and/or wireline communication medium in a client/server context. The client/server environment is a computational architecture that involves a client process (i.e., a client) requesting service from a server process (i.e., a server). In general, the client/server environment maintains a distinction between processes, although client and server processes may operate on different machines or on the same machine. Accordingly, the client and server sides of the client/server environment are referred to as being logically separated. Usually, when client and server processes operate on separate devices, each device can be customized for the needs of the respective process. For example, a server process can “run on” a system having large amounts of memory and disk space, whereas the client process often “runs on” a system having a graphic user interface provided by high-end video cards and large-screen displays.

A client can be a program, such as a web browser, that requests information, such as web pages, from a server under the control of a user. Examples of clients include browsers such as Netscape Navigator® (America Online, Inc., Dulles, Va.) and Internet Explorer® (Microsoft Corporation, Redmond, Wash.). Browsers typically provide a graphical user interface for retrieving and viewing web pages, web portals, applications, and other resources served by Web servers. A SOAP client can be used to request web services programmatically by a program in lieu of a web browser. The applications provided by the service providers may execute on a server. The server can be a program that responds to the requests from the client. Some examples of servers are International Business Machines Corporation's family of Lotus Domino® servers, the Apache server and Microsoft's Internet Information Server (IIS) (Microsoft Corporation, Redmond, Wash.).

The clients and servers can communicate using a standard communications mode, such as Hypertext Transport Protocol (HTTP) and SOAP. According to the HTTP request-response communications model, HTTP requests are sent from the client to the server and HTTP responses are sent from the server to the client in response to an HTTP request. In operation, the server waits for a client to open a connection and to request information, such as a Web page. In response, the server sends a copy of the requested information to the client, closes the connection to the client, and waits for the next connection. It will be understood that the server can respond to requests from more than one client.

Although FIG. 1 illustrates an exemplary communication network, it will be understood that the present invention is not limited to such configurations, but is intended to encompass any configuration capable of carrying out the operations described herein.

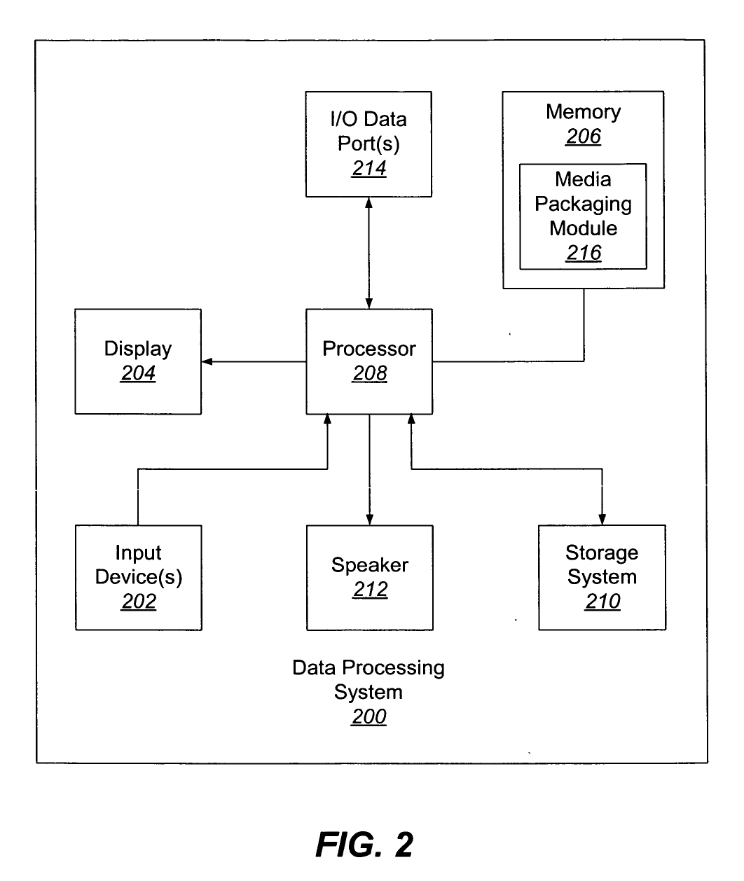

Referring now to FIG. 2, a data processing system 200 that may be used to implement the media content server of FIG. 1, in accordance with some embodiments of the present invention, comprises input device(s) 202, such as a keyboard or keypad, a display 204, and a memory 206 that communicate with a processor 208. The data processing system 200 may further include a storage system 210, a speaker 212, and an input/output (I/O) data port(s) 214 that also communicate with the processor 208. The storage system 210 may include removable and/or fixed media, such as floppy disks, ZIP drives, hard disks, or the like, as well as virtual storage, such as a RAMDISK. The I/O data port(s) 214 may be used to transfer information between the data processing system 200 and another computer system or a network (e.g., the Internet). These components may be conventional components, such as those used in many conventional computing devices, and their functionality, with respect to conventional operations, is generally known to those skilled in the art. The memory 206 may be configured with a media packaging module 216 that may be used to distribute locked content on a communication network in accordance with some embodiments of the present invention.

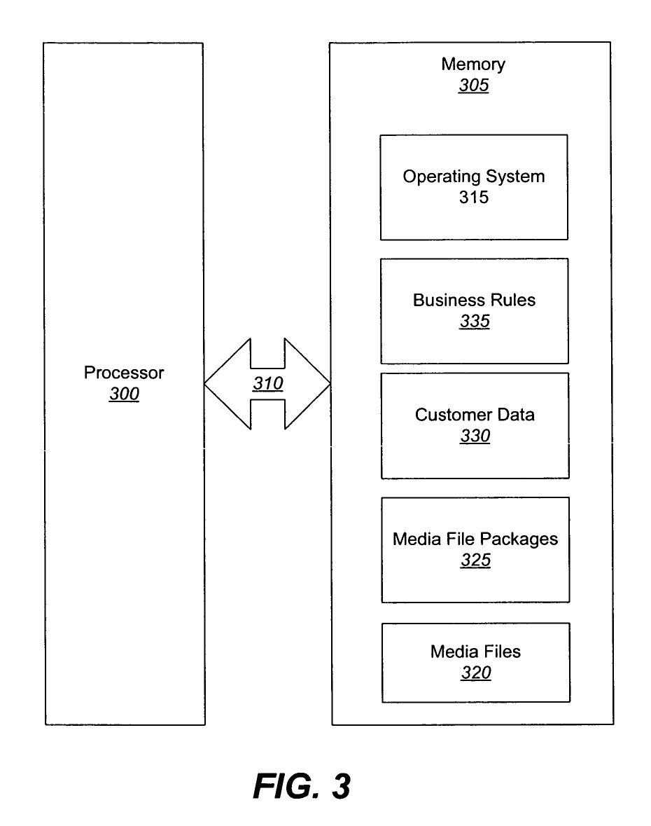

FIG. 3 illustrates a processor 300 and memory 305 that may be used in embodiments of data processing systems, such as the data processing system 200 of FIG. 2, in which associated content can be delivered on a communication network in accordance with some embodiments of the present invention. The processor 300 communicates with the memory 305 via an address/data bus 310. The processor 300 may be, for example, a commercially available or custom microprocessor. The memory 305 is representative of the one or more memory devices containing the software and data used for delivering locked content on a communication network in accordance with some embodiments of the present invention. The memory 305 may include, but is not limited to, the following types of devices: cache, ROM, PROM, EPROM, EEPROM, flash, SRAM, and DRAM.

As shown in FIG. 3, the memory 305 may contain up to five or more categories of software and/or data: an operating system 315, media files 320, media file packages comprising media files with associated additional content elements 325, a customer data module 330, and a business rules module 335. The operating system 315 generally controls the operation of the data processing system. In particular, the operating system 315 may manage the data processing system's software and/or hardware resources and may coordinate execution of programs by the processor 300. The media file packages module 325 may be a database and/or a data structure that can be used to create associations between media files. In accordance with some embodiments of the present invention, the associations may comprise primary media files with additional content elements that are associated therewith. The customer data module 330 may include information on customers' previous purchases or behaviors. The customer data module 330 may also include profile information for customers that contains customers' media preferences. Financial accounts for individual customers may also be stored as part of the customer data module 330. The customer data module 330 may further comprise a personal storage area where individual customers may store media files that have been purchased. Alternatively, in other embodiments, customers may have personal storage areas on other servers, e.g., media storage server 135 of FIG. 1, provided by the same or other service providers. The business rules module 335 may contain various rules and algorithms that are used to determine the price structure for the various additional content elements that are associated and packaged with the media files. The pricing for additional content elements may be based on various factors, including, but not limited to, a particular customer's previous purchases and the particular media that the content element(s) are associated with.

Although FIG. 3 illustrates exemplary hardware/software architectures that may be used in data processing systems, such as the data processing system 200 of FIG. 2, for delivering locked content on a communication network, it will be understood that the present invention is not limited to such a configuration but is intended to encompass any configuration capable of carrying out operations described herein. Moreover, the functionality of the media content server 110, media storage server 135 of FIG. 1, the data processing system 200 of FIG. 2, and the hardware/software architecture of FIG. 3 may be implemented as a single processor system, a multi-processor system, or even a network of stand-alone computer systems, in accordance with various embodiments of the present invention.

Computer program code for carrying out operations of data processing systems discussed above with respect to FIG. 3 may be written in a high-level programming language, such as Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

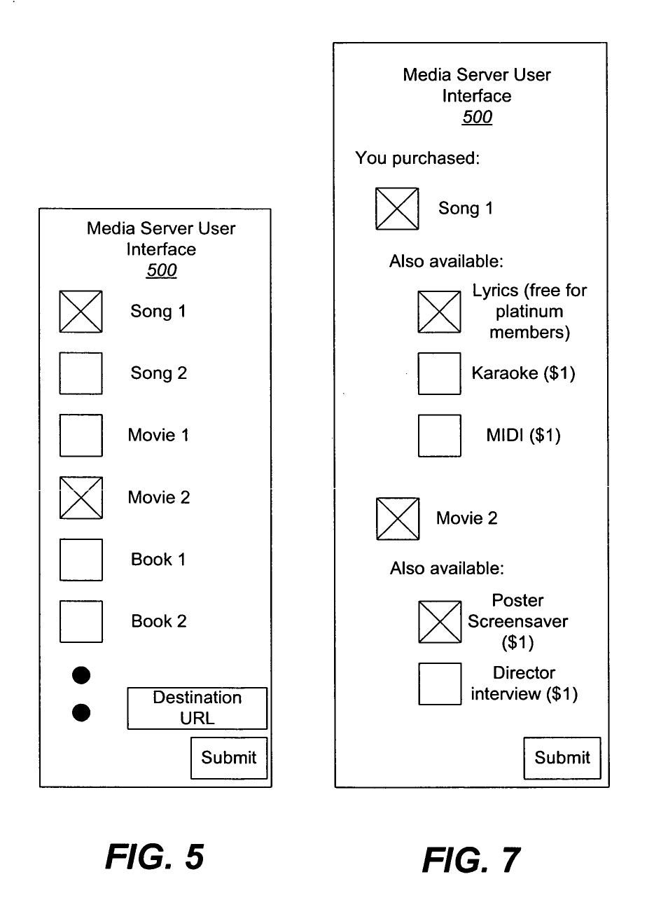

Exemplary operations for delivering associated content on a communication network will now be described with reference to FIGS. 4, 5, and 1. Operations begin at block 400 where the media content server 110 detects that a customer has logged in using, for example, the personal computer 120 and/or the mobile terminal 130. As shown in FIG. 5, the media content server 110 may provide a media server interface 500 in which a variety of media files are presented to the user for purchase and/or downloading. In the example shown, multiple songs, movies, and recorded books are made available to the customer. At block 405, the customer may select one or more media files, which is illustrated in the FIG. 5 example as a selection of song 1 and movie 2. Unbeknownst to the customer at this time, the song 1 and movie 2 have additional content elements that are associated therewith. As discussed above, one or more of the additional content elements may be free with the purchase of the media file(s) or the additional content elements may be priced using business rules (i.e., the business rule module 335) and various pricing factors in accordance with various embodiments of the present invention. These factors may include, but are not limited to, a particular customer's previous purchases and the particular media that the additional content elements are associated with.

At block 410, the customer is presented with a choice as to how the selected media file(s) and associated additional content element(s) are to be delivered. In accordance with various embodiments of the present invention, the media content server 110 may provide access to the media file(s) and/or the associated additional content element(s) by communicating the media file(s) and the associated additional content element(s) to a destination, such as the personal computer 120 or the wireless phone 130, which may be operated by the customer. Alternatively, the media content server 110 may communicate the media file(s) and the associated additional content element(s) to a storage device operated by a service provider, such as media storage server 135 or media content server 110 of FIG. 1 that includes a storage area associated with the customer, such as the customer data area 330 of FIG. 3.

At block 415, the package of media file(s) and associated content elements may be communicated or downloaded to the destination identified by the customer. In the example shown in FIG. 5, the customer identifies a destination URL for downloading song 1 and movie 2. In other examples, the customer may enter a phone number to download the media files to a mobile terminal or may simply leave the destination field blank and download the media files to the device or system that the customer is using to access the media content server 110 via the media server user interface 500.

Referring now to FIGS. 6, 7, and 1, once the media file(s) and associated content elements have been communicated to the customer's desired destination, the customer may be notified about the additional content that is associated with the received media file(s). In accordance with some embodiments of the present invention, once the user attempts to open the media file package that has been downloaded, the customer's browser is invoked and the user is presented with one or more additional content elements that are associated with the media file(s) that have been obtained at block 600. As shown in the FIG. 7 example, the customer's browser may access the media content server 110 via the media server user interface 500 to display the media files song 1 and movie 2 that have been purchased along with the additional content elements that are associated with each media file.

At block 605, a customer may select one or more of the associated content elements that the customer would like to obtain. In the FIG. 7 example, a customer has selected the lyrics for song 1, which are free to this customer because he/she has platinum member status, and the poster screensaver for movie 2, which costs one dollar. These selections are then submitted to the media content server 110 using the media server user interface 500, which communicates keys for the associated content elements, e.g., lyrics and screensaver, to the customer that can be used by the customer to access or unlock the associated content elements. As a result, the customer can now use the previously unaccessible content elements that were packaged with the media file(s) that the customer downloaded. The customer may maintain a financial account on the media content server 110 via the customer data module 330 of FIG. 3, which is then updated accordingly based on the media files and associated additional content element(s) that are purchased.

In further embodiments of the present invention, the media file(s) and/or the additional content element(s) that are associated therewith may protected through one or more digital rights management (DRM) measures. These DRM measures may restrict the way that a customer may use, reproduce, and/or manipulate the media file(s) and/or the additional content elements. The DRM may include an attached media rule (AMR) that is associated with the media file(s) and/or the additional content element(s). The AMR may include, but is not limited to, information such as price, expiration date, type of offer the package was purchased under, and/or other media enablement. As an example of “other media enablement,” the AMR may state that the purchase of sheet music allows the customer to obtain the MIDI information for free. The AMR may identify the MIDI information using the stock-keeping unit (SKU) assigned to the MIDI information. In general, a SKU is an identifier that is used by merchants to permit the systematic tracking of products and services offered to customers. Note that the AMR may be specific in that purchase of the sheet music allows free acquisition of the MIDI information, but purchase of the MIDI information may not allow free acquisition of the sheet music.

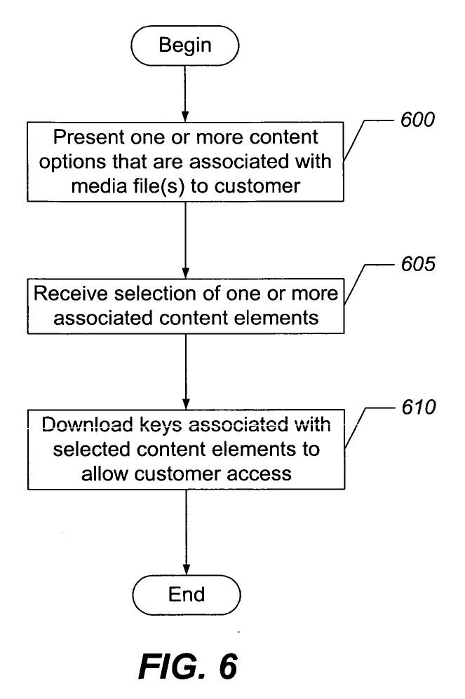

The AMR may also be used to allow a customer to access or unlock associated content element(s) based on information contained in the AMR. For example, the AMR may identify a particular media file by SKU such that if a customer has that media file, then they are allowed to access or unlock one or more associated content elements. For example, a customer may purchase a song from a particular artist and later purchase a second song from the same artist in which a wallpaper file is included as additional locked content. The AMR for the second song may identify the first song by SKU as indicating that the additional wallpaper file may be offered to the customer for free due to the purchase of the first song. Thus, when the customer attempts to open the second song file, he/she may be presented with an offer for the free wallpaper file as discussed above with respect to FIGS. 6 and 7.

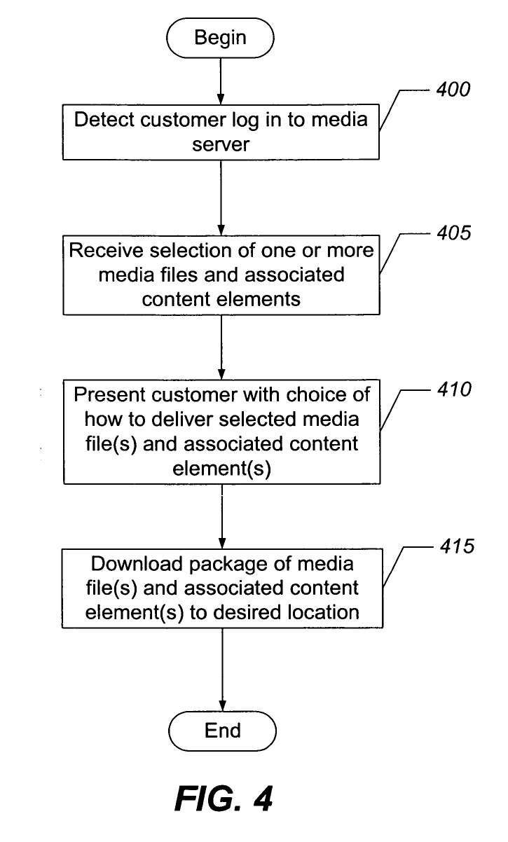

The flowcharts of FIGS. 4 and 6 illustrate the architecture, functionality, and operations of some embodiments of methods, systems, and computer program products for delivering associated content on a communication network. In this regard, each block represents a module, segment, or portion of code, which comprises one or more executable instructions for implementing the specified logical function(s). It should also be noted that in other implementations, the function(s) noted in the blocks may occur out of the order noted in FIGS. 4 and 6. For example, two blocks shown in succession may, in fact, be executed substantially concurrently or the blocks may sometimes be executed in the reverse order, depending on the functionality involved.

Many variations and modifications can be made to the preferred embodiments without substantially departing from the principles of the present invention. All such variations and modifications are intended to be included herein within the scope of the present invention, as set forth in the following claims.

That which is claimed:

1. A method of delivering associated content on a communication network, comprising:
associating media files with additional content elements;
receiving a selection of one of the media files;
communicating the selected one of the media files and at least one additional content element associated therewith to a destination; and
providing access to the at least one additional content element.

2. The method of claim 1, wherein communicating the selected one of the media files comprises:
communicating the selected one of the media files and at least one additional content element associated therewith to a storage device operated by a service provider and comprising a storage area associated with a user.

3. The method of claim 1, wherein communicating the selected one of the media files comprises:
communicating the selected one of the media files and at least one additional content element associated therewith to a device operated by a user.

4. The method of claim 1, wherein providing access to the at least one additional content element comprises:
receiving a user selection of the at least one additional content element responsive to communicating the selected one of the media files and the at least one additional content element to the destination; and
communicating an access key for the at least one additional content element to the destination.

5. The method of claim 4, wherein the access key is configured to unlock the at least one additional content element for use by a user.

6. The method of claim 1, further comprising:
assigning a price to the at least one additional content element based on the selection of the at least one of the media files and/or a user's previous purchases of media files and/or additional content elements associated therewith.

7. The method of claim 1, wherein associating media files with additional content elements comprises associating additional content elements with media files based on a user's previous purchases of additional content elements and/or media files.

8. The method of claim 1, wherein associating media files with additional content elements comprises associating additional content elements with media files based on a user profile that defines the user's media preferences.

9. The method of claim 1, wherein the selected one of the media files and/or the at least one additional content element has an attached media rule (AMR) associated therewith.

10. The method of claim 9, wherein the AMR comprises price information, expiration date information, purchase information, and/or media enablement information.

11. The method of claim 10, wherein the media enablement information comprises information related to accessing the at least one additional content element.

12. The method of claim 10, wherein the media enablement information comprises information related to a media file other than the selected one of the media files and the at least one additional content element.

13. A method of operating a user interface for delivering content on a communication network, comprising:
presenting at least one media file to a user, the at least one media file having at least one additional content element associated therewith;
receiving a selection from the user of one of the at least one media file;
communicating the selected one of the at least one media file and the at least one additional content element associated therewith to a destination;
presenting the at least one additional content element to the user responsive to a user selection of the at least one media file at the destination.

14. The method of claim 13, further comprising:
receiving a selection from the user of the at least one additional content element; and
communicating an access key for the at least one additional content element to the destination responsive to receiving the selection from the user of the at least one additional content element.

15. The method of claim 14, wherein the access key is configured to unlock the at least one additional content element for use by a user.

16. The method of claim 13, wherein presenting the at least one additional content element to the user comprises:
presenting a price of the at least one additional content element to the user that is based on the selection of the at least one of the media files and/or a user's previous purchases of media files and/or additional content elements associated therewith.

17. A system for delivering associated content on a communication network, comprising:
a content server that is configured to access a plurality of media files having additional content elements associated therewith, the content server being further configured to receive a selection of one of the media files and to communicate the selected one of the media files and at least one additional content element associated therewith to a destination such that access is provided to the at least one additional content element.

18. The system of claim 17, further comprising:
a service provider storage device that comprises a storage area associated with a user;
wherein the content server is further configured to communicate the selected one of the media files and at least one additional content element associated therewith to the storage device operated by the service provider.

19. The system of claim 17, further comprising:
a user device;
wherein the content server is further configured to communicate the selected one of the media files and at least one additional content element associated therewith to the user device.

20. The system of claim 17, wherein the content server is further configured to receive a user selection of the at least one additional content element responsive to communicating the selected one of the media files and the at least one additional content element to the destination, and to communicate an access key for the at least one additional content element to the destination.

21. The system of claim 20, wherein the access key is configured to unlock the at least one additional content element for use by a user.

22. A computer program product for delivering associated content on a communication network, comprising:
a computer readable storage medium having computer readable program code embodied therein, the computer readable program code comprising:
computer readable program code configured to associate media files with additional content elements;
computer readable program code configured to receive a selection of one of the media files;
computer readable program code configured to communicate the selected one of the media files and at least one additional content element associated therewith to a destination; and
computer readable program code configured to provide access to the at least one additional content element.

23. The computer program product of claim 22, wherein the computer readable program code configured to provide access to the at least one additional content element comprises:
computer readable program code configured to receive a user selection of the at least one additional content element responsive to communicating the selected one of the media files and the at least one additional content element to the destination; and
computer readable program code configured to communicate an access key for the at least one additional content element to the destination.

24. The computer program product of claim 22, further comprising:
computer readable program code configured to assign a price to the at least one additional content element based on the selection of the at least one of the media files and/or a user's previous purchases of media files and/or additional content elements associated therewith.

25. The method of claim 22, wherein the computer readable program code configured to associate media files with additional content elements comprises computer readable program code configured to associate additional content elements with media files based on a user's previous purchases of additional content elements and/or media files.

26. The method of claim 22, wherein the computer readable program code configured to associate media files with additional content elements comprises computer readable program code configured to associate additional content elements with media files based on a customer profile that defines the customer's media preferences.

27. A computer program product for operating a user interface for delivering content on a communication network, comprising:
a computer readable storage medium having computer readable program code embodied therein, the computer readable program code comprising:
computer readable program code configured to present at least one media file to a user, the at least one media file having at least one additional content element associated therewith;
computer readable program code configured to receive a selection from the user of one of the at least one media file;
computer readable program code configured to communicate the selected one of the at least one media file and the at least one additional content element associated therewith to a destination;
computer readable program code configured to present the at least one additional content element to the user responsive to a user selection of the at least one media file at the destination.

28. The computer program product of claim 27, further comprising:
computer readable program code configured to receive a selection from the user of the at least one additional content element; and
computer readable program code configured to communicate an access key for the at least one additional content element to the destination responsive to receiving the selection from the user of the at least one additional content element.

29. The computer program product of claim 27, wherein the computer readable program code configured to present the at least one additional content element to the user comprises:
computer readable program code configured to present a price of the at least one additional content element to the user that is based on the selection of the at least one of the media files and/or a user's previous purchases of media files and/or additional content elements associated therewith.
